(19) United States
(12) Patent Application Publication
(10) Pub. No.: US 2026/0162432 A1
(43) Pub. Date: Jun. 11, 2026

(54) ARTIFICIAL INTELLIGENCE HAZARD IDENTIFICATION SYSTEM

(71) Applicants: YI HUNG WONG, Tainan City (TW); PO KAI CHANG, Chiayi City (TW); CHANG-DAR ENGINEERING & CONSTRUCTION CO., LTD, Shuishang Township (TW)

(72) Inventors: Yi Hung Wong, Tainan City (TW); Po Kai CHANG, Chiayi City (TW); Chia Jung CHANG, Shuishang Township (TW); Chung Nan CHENG, Shuishang Township (TW)

(21) Appl. No.: 19/013,188

(22) Filed: Jan. 8, 2025

(30) Foreign Application Priority Data
Dec. 9, 2024 (TW) 113213549

(51) Int. Cl. G06V 20/52; G06F 21/31; G06V 10/20; G06V 10/774; G06V 10/776; G06V 10/82

(52) U.S. Cl. CPC G06V 20/52; G06F 21/31; G06V 10/20; G06V 10/774; G06V 10/776; G06V 10/82

(57) ABSTRACT

A hazard identification system, applicable to a server is provided, including: an image receiving module, which receives workplace images through a network and outputs raw images; a model training module, which trains a machine learning model using the raw images; an image detection module, which analyzes the raw images using the trained model with artificial intelligence algorithms and produces post-detection images; a hazard identification module, which analyzes each object in the post-detection images and generates and outputs warning notifications if safety risks are identified; application notification module, which sends warning notification to user application for notification. The hazard identification system of the present disclosure enables real-time identification of potential workplace hazards through high-accuracy image detection.

### CROSS-REFERENCE TO RELATED APPLICATION

This application claims the benefit of priority under 35 USC § 119 (a) to Taiwanese Patent Application No. 113213549, filed on Dec. 9, 2024, the entire disclosure of which is incorporated herein by reference.

### FIELD OF TECHNOLOGY

The following relates to an artificial intelligence hazard identification system, and more particularly, to a system that utilizes artificial intelligence and real-time image recognition technology to identify potential hazards in a workplace and promptly notify management personnel, thereby enhancing workplace operational safety.

### BACKGROUND

Traditionally, workplace safety management in construction primarily relies on the experience and observation of on-site supervisors. However, this approach has limitations in terms of monitoring scope and real-time responsiveness, especially when supervisors cannot detect potential hazards in real time, the safety risks for workers in the workplace increase.

With the maturity of artificial intelligence technology, it is possible to use image recognition technology to detect hazards to improve workplace safety. However, existing hazard identification systems still have room for improvement in terms of detection accuracy and real-time notification functions.

### SUMMARY

An aspect relates to a hazard identification system that utilizes artificial intelligence methods to identify surveillance images in a workplace, enabling the immediate identification of potential hazards and enhancing workplace operational safety through real-time notification functionality.

The present disclosure provides an artificial intelligence hazard identification system, which is applicable to a server, comprising:
an image receiving module configured to receive real-time images of a workplace via a network and output raw images;
an intelligent image analysis module connected to the image receiving module, which includes: a model training module configured to train a machine learning model using the raw images to obtain a trained model;
an image detection module configured to analyze the raw images using the trained model with artificial intelligence algorithms to generate detected images;
a hazard identification module, connected to the intelligent image analysis module, configured to analyze objects in the detected images and, if safety risk factors are identified, generate and output a warning notification;
an application notification module, connected to the hazard identification module, configured to transmit the warning notification to a user application for notification.

Furthermore, the safety risk factors may include at least one condition of: personnel not wearing safety protection equipment, personnel being too close to machinery or vehicles, and personnel entering restricted areas.

Furthermore, the raw images may be further divided into a train dataset and a valid dataset, with a data volume ratio of the train dataset to the valid dataset being 80:20.

Furthermore, the artificial intelligence algorithm may be an object detection algorithm; the object detection algorithm may be at least one selected from a group consisting of YOLO, Faster R-CNN, Single Shot MultiBox Detector, RetinaNet, EfficientDet and CenterNet.

Furthermore, the image detection module uses SAHI post-processing for small object detection.

Furthermore, the model training module may further include a model accuracy evaluation module to evaluate accuracy of the machine learning model trained by the model training module.

Furthermore, the artificial intelligence hazard identification system of the present disclosure may further include an image augmentation module, which is connected to the image receiving module and the intelligent image analysis module, and is configured to adjust the image size of the raw images and performs data augmentation on the raw images using multiple data augmentation methods.

Furthermore, the artificial intelligence hazard identification system of the present disclosure may further include a streaming webpage display module, which is connected to the intelligent image analysis module and is configured to transmit the detected images to a live webpage to provide real-time images.

Furthermore, the data augmentation method may include at least one selected from a group consisting of random flipping, rotation, brightness adjustment, contrast adjustment, Gaussian blur, cropping, adding salt-and-pepper noise, elastic transformation, addition of motion blur, X-axis shearing, Y-axis shearing, sharpening, piecewise affine transformation, gray scaling, saturation adjustment, gamma contrast adjustment, color temperature adjustment, perspective transformation, coarse random dropout, color inversion, addition of Gaussian noise, addition of Poisson noise, Dropout2d, edge detection, HSV color space modification, brightness modification, and addition of splash effects.

Furthermore, the artificial intelligence hazard identification system of the present disclosure may further comprise a user management module connected to the intelligent image analysis module and the application notification module, and is configured to perform authentication based on user account and password;
if the authentication is successful, a permission authentication is output to the image detection module to enable the image detection module to perform object detection;
if the authentication is failed, a rejection authentication is output to the application notification module to notify an abnormal login attempt.

Furthermore, the application notification module may store the warning notification in a temporary storage area of the server.

By utilizing the artificial intelligence hazard identification system of embodiments of the present invention, real-time images of the worksite may be used for object detection and hazard identification, enabling immediate and effective management of workplace safety conditions.

In addition, the artificial intelligence hazard identification system of the present disclosure may generate a larger amount of learning data through image augmentation technology, improving the accuracy of the machine learning model in image recognition.

In addition, the artificial intelligence hazard identification system of the present disclosure may incorporate SAHI post-processing to enhance the accuracy of small object detection.

In addition, the artificial intelligence hazard identification system of embodiments of the present invention, upon detecting safety risk factors, may immediately generate a warning notification and output it to the user application, so that the management personnel may understand the on-site situation in real time and address safety concerns.

In addition, the artificial intelligence hazard identification system of the present disclosure may be equipped with a user management function, ensuring system security through identity authentication and access frequency limitations.

In summary, the present disclosure provides an artificial intelligence hazard identification system capable of real-time identification of potential hazards in workplace through highly accurate image detection and immediately notify management personnel through an application, thereby preventing possible accidents. In addition, embodiments of the system may include robust login management features to enhance the security of embodiments of the system.

### BRIEF DESCRIPTION

Some of the embodiments will be described in detail, with reference to the following figures, wherein like designations denote like members, wherein:

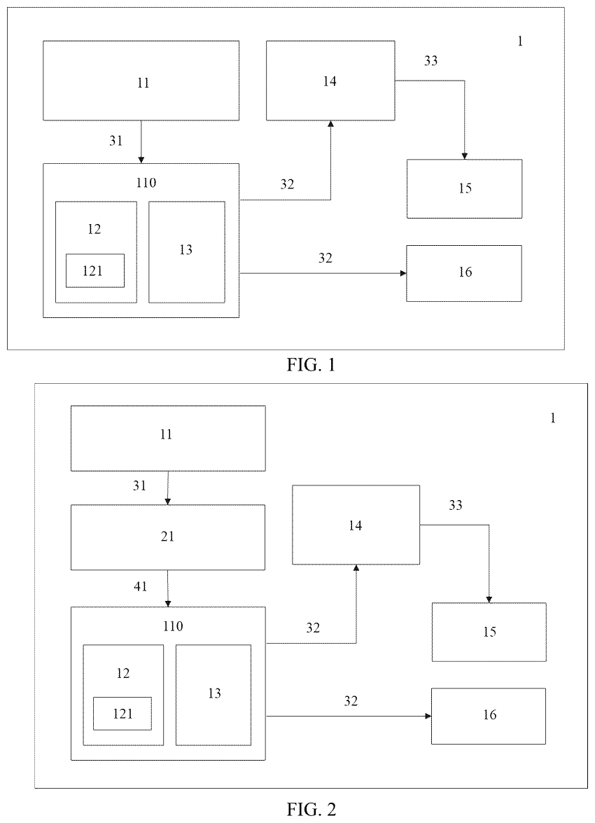

FIG. 1 shows a schematic diagram of the unit combination of a hazard identification system according to an embodiment of the present disclosure;

FIG. 2 shows a schematic diagram of the unit combination of a hazard identification system according to an embodiment of the present disclosure;

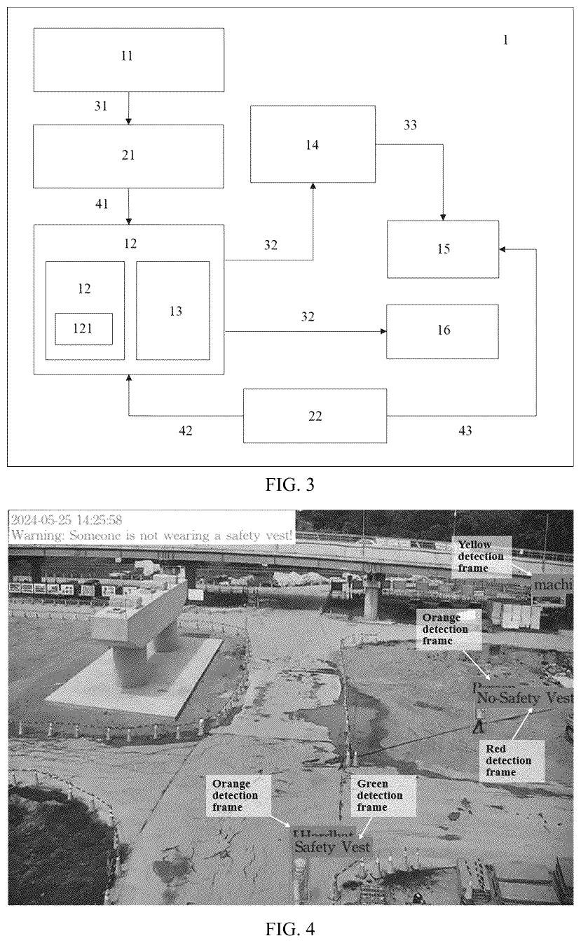

FIG. 3 shows a schematic diagram of the unit combination of a hazard identification system according to an embodiment of the present disclosure;

FIG. 4 shows a detected image obtained by the image detection module according to an embodiment of the present disclosure through analysis using an artificial intelligence algorithm;

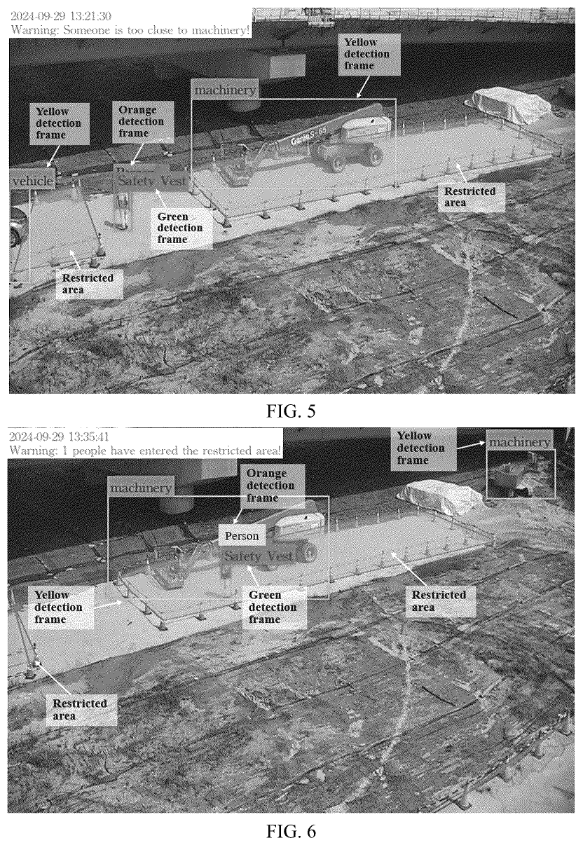

FIG. 5 shows a detected image obtained by the image detection module according to an embodiment of the present disclosure through analysis using an artificial intelligence algorithm;

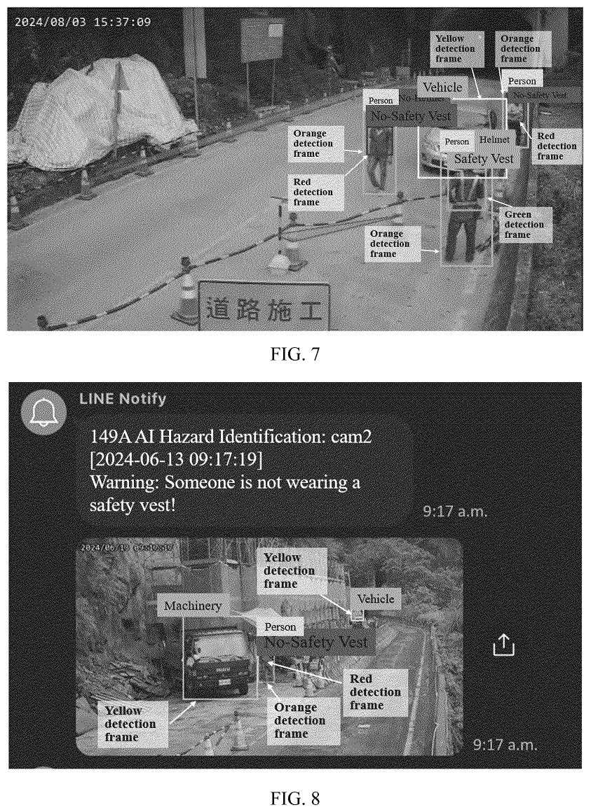

FIG. 6 shows a detected image obtained by the image detection module according to an embodiment of the present disclosure through analysis using an artificial intelligence algorithm;

FIG. 7 shows a detected image obtained by the image detection module according to an embodiment of the present disclosure through analysis using an artificial intelligence algorithm;

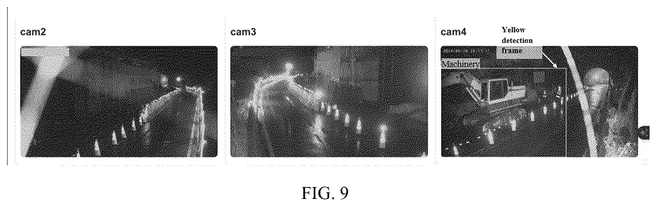

FIG. 8 shows a schematic diagram of the implementation of the system according to an embodiment of the present disclosure sending warning notifications to user applications; and

FIG. 9 shows a webpage of the system according to an embodiment of the present disclosure, displaying real-time image recognition results in real time.

### DETAILED DESCRIPTION

The following is an exemplary embodiment to illustrate an embodiment of the hazard identification system 1 of the present disclosure. It should be noted that the following exemplary embodiment is provided solely for illustrative purposes and is not intended to limit the scope of the present disclosure.

FIG. 1 is a schematic diagram of the unit combination of a hazard identification system according to an embodiment of the present disclosure; FIG. 2 is a schematic diagram of the unit combination of a hazard identification system according to an embodiment of the present disclosure; FIG. 3 is a schematic diagram of the unit combination of a hazard identification system according to an embodiment of the present disclosure; FIG. 4 is a detected image obtained by the image detection module according to an embodiment of the present disclosure through analysis using an artificial intelligence algorithm; FIG. 5 is a detected image obtained by the image detection module according to an embodiment of the present disclosure through analysis using an artificial intelligence algorithm; FIG. 6 is a detected image obtained by the image detection module according to an embodiment of the present disclosure through analysis using an artificial intelligence algorithm; FIG. 7 is a detected image obtained by the image detection module according to an embodiment of the present disclosure through analysis using an artificial intelligence algorithm; FIG. 8 is a schematic diagram of the implementation of embodiments of the system according to an embodiment of the present disclosure sending warning notifications to user applications; FIG. 9 is a webpage of embodiments of the system according to an embodiment of the present disclosure, displaying real-time image recognition results in real time.

The hazard identification system 1 of the present disclosure is applicable to a server. As shown in FIG. 1, the hazard identification system 1 of the present disclosure comprises an image receiving module 11, an intelligent image analysis module 110, a hazard identification module 14, an application notification module 15; wherein the intelligent image analysis module 110 includes a model training module 12 and an image detection module 13.

The image receiving module 11 receives real-time images of the workplace through the network and outputs the raw images 31 for subsequent model training and object detection. The real-time images of the workplace may be the monitoring images of the live broadcast images received through cv2, or the monitoring images directly input by the cameras at the work site. The image receiving module 11 may also simultaneously receive multiple real-time images from different webpages, so as to realize simultaneous monitoring of multiple workplaces.

After the intelligent image analysis module 110 receives the raw image 31, the model training module 12 uses the raw image 31 as training data to train the machine learning model to obtain a trained model for image recognition. Herein, the raw images 31 may be further divided into a train dataset and a valid dataset, with the data ratio typically ranging from 80:20 to 90:10. Generally, the train dataset is used for training the machine learning model, while the valid dataset is utilized to evaluate the model's training trends and results through cross-validation methods, such as checking whether there is overfitting or uneven distribution of training data, to avoid undesirable analysis results in subsequent applications.

Subsequently, the image detection module 13 utilizes the trained model to perform image detection analysis using artificial intelligence algorithms, producing the detected image 32. Users may predefine the objects to be displayed in the detected image 32, such as workers, vehicles, machinery, helmets, cones, masks, safety vests, etc., and these objects and their states may be differentiated using detection frames in specified colors, thereby enabling the users of management to more effectively and accurately determine the status of the workplace, and these settings may be stored within embodiments of the system for convenient subsequent use.

In an embodiment, the artificial intelligence algorithm used in the image detection module 13 may be an object detection algorithm, and the object detection algorithm may be YOLO (including YOLOv5, YOLOv8, YOLOv10, YOLO11 and the like.), and a p-2 layer may be added to the head in YOLO to improve the detection ability of small objects.

Additionally, the image detection module 13 also defines restricted areas based on the area enclosed by traffic cones. Specifically, after detecting the positions of all traffic cones, the central coordinates of these traffic cones in the image are captured, the center coordinates are then clustered using clustering algorithms, such as HDBSCAN (Hierarchical Density-Based Spatial Clustering of Applications with Noise). After clustering, each group of traffic cones is connected using an bounding shape, thereby defining several independent restricted area. Additionally, the image detection module 13 may further incorporate the Slicing Aided Hyper Inference method for small object detection (SAHI) for post-processing. SAHI enhances detection accuracy, particularly for small and rare objects, by dividing the image into several slices, performing object detection on each slice, and then merging the results.

In embodiments, the object detection algorithm may include but not limited to Faster Region with Convolution Neural Network (Faster R-CNN), Single Shot MultiBox Detector (SSD), RetinaNet, EfficientDet, CenterNet, and the like.

Faster Region with Convolution Neural Network (Faster R-CNN): A convolutional neural network based on a Region Proposal Network (RPN) that enables high-precision object detection, suitable for scenarios requiring high accuracy.

Single Shot Multibox Detector (SSD): An end-to-end object detection network with a faster detection speed, suitable for application scenarios requiring high real-time performance.

RetinaNet: Utilizing Focal Loss as the loss function to effectively address the imbalance between positive and negative samples, making it suitable for detecting small and rare objects.

EfficientDet: Based on the EfficientNet backbone network, it has high detection efficiency and accuracy and is suitable for resource-constrained devices.

CenterNet: Detecting objects based on their central points, with high accuracy and efficiency, and is suitable for application scenarios that require precise positioning.

The image detection module 13 may adjust different object detection algorithms during a single image analysis based on actual conditions. For example, the algorithm may be switched according to set parameters to meet the specific needs of various scenarios, enhancing the flexibility of embodiments of the system in image detection.

Additionally, the model training module 12 may further include a model accuracy evaluation module 121 to evaluate the accuracy of the machine learning model trained by the model training module 12. When using the YOLO algorithm, a valid dataset compliant with YOLO format should first be prepared, which includes an Images folder for storing multiple image files and a Labels folder for storing labelled files corresponding to the image files. After creating the above folder, the trained YOLO model is used and the server's built-in val ( ) function is utilized to evaluate the model's accuracy.

Furthermore, when further incorporating SAHI processing with the YOLO algorithm, the valid dataset should first be converted into a VOC dataset, and then the trained YOLO model is loaded using the SAHI function to start evaluating the VOC dataset, obtaining parameters such as mAP50 and mAP50-95 of mean average precision (mAP).

In an embodiment, the hazard identification system 1 of the present disclosure may further include a streaming webpage display module 16. The intelligent image analysis module 110 transmits the detected image 32 to the streaming webpage display module 16. The streaming webpage display module 16 uses network transmission protocols such as Web Socket to upload the image to a network platform for real-time streaming, enabling management personnel to monitor workplace conditions at any time.

The hazard identification module 14 analyzes each detected object in the detected image 32. If a safety risk factor that may cause danger is identified, such as a worker not wearing a safety vest or helmet or other safety protection equipment, worker being too close to machinery or vehicles, or worker entering restricted area, a warning notification 33 is immediately generated and output to the application notification module 15. The warning notification 33 includes a warning message and a corresponding detected image 32. The application notification module 15 then sends the warning notification 33 to the user application, informing management personnel of safety concerns in the workplace. These security risk factors may be set by the user in advance and stored in embodiments of the system for convenient subsequent use.

For example, when the hazard identification module 14 determines whether a worker is too close to a machinery or a vehicle, it first analyzes the detection frame of each worker and the surrounding vehicles or machinery and calculates the detection frame of the worker. The width and height of the detection frame for each worker are calculated, derives the detection frame area for the worker, and simultaneously calculates the detection frame area for the vehicles or machinery. Based on the area of the detection frame calculated above, it determines the relative position and distance between the worker and the vehicles or machinery.

Specifically, the hazard identification module 14 determines whether workers maintain a safe distance from vehicles or machinery based on an area ratio rule. This area ratio rule sets a predefined area ratio based on different types of machinery or vehicles, serving as a standard for determining the distance between the workers and vehicles or machinery. Generally, when the area of the worker is smaller than the area of the vehicles or machinery, it means that the distance between the worker and the equipment is farther; conversely, when the area ratio increases, it means that the distance between the worker and the equipment is reduced.

For vehicles, due to their mobility and the characteristics of the workplace, the predefined threshold ratio of the worker's area to the vehicle's area is set to 0.1. When the ratio of the worker's area to the vehicle's area is less than 0.1, it means that the worker is positioned at a farther distance from the vehicle, signifying that a safe distance is maintained; if the ratio exceeds 0.1, it means that the worker is close to the vehicle and may be in a dangerous range. For machinery, since their operational range and danger area are smaller, the predefined threshold ratio is set to 0.05. When the ratio of the worker's area to the machinery's area exceeds 0.05, it is determined that the worker may have entered the hazardous area. The threshold ratio of the area of workers to the area of vehicle or machinery is not specifically limited to a fixed value and may vary depending on the specifications of the equipment and the conditions of the workplace.

In summary, the hazard identification module 14 utilizes the area ratio rule to determine whether workers maintain a sufficient safe distance from equipment, based on the type of vehicle or machinery by setting a predetermined threshold ratio. The area ratio rule reflects the actual physical distance between workers and vehicles or machinery through the relative size of their detection frames. When the ratio of the worker's detection frame area to the detection frame area of the vehicle or machinery exceeds the predetermined threshold ratio, the hazard identification module 14 immediately generates a warning notification 33 to notify management personnel to eliminate the dangerous situation, ensuring the safety of personnel on-site.

Additionally, the hazard identification module 14 determines whether the distance between workers and vehicles or machinery is too close based on predetermined horizontal and vertical danger distances. The horizontal danger distance, Xa, is set to five times the worker's width, and the vertical danger distance, Ya, is set to 1.5 times the worker's height. The hazard identification module 14 calculates the minimum horizontal distance, Xₘᵢₙ, and the minimum vertical distance, Yₘᵢₙ, between the worker and the vehicle or machinery. If Xₘᵢₙ≤X_{d} and Yₘᵢₙ≤Y_{d}, it is determined that the worker is within the hazardous distance range. At this point, the hazard identification module 14 generates a warning notification 33 to notify the management personnel for further action.

In addition, the hazard identification module 14 determines whether the worker is a driver, or a passenger based on the positions of the worker's detection frame and the vehicle's detection frame to avoid misjudgment of the safety distance. Specifically, the hazard identification module 14 first determines that the bottom edge position of the worker's detection frame should be located above the bottom edge position of the vehicle's detection frame, and the distance between the bottom edge of the worker's detection frame and the bottom edge of the vehicle's detection frame should be half of the worker's height; next, it evaluates that the left and right edges of the worker's detection frame should not exceed the left and right edges of the vehicle's detection frame by more than half the worker's width, and the top edge of the worker's detection frame should be lower than the top edge of the vehicle's detection frame; finally, it verifies that the worker's height does not exceed half of the vehicle's height. Based on this, if the hazard identification module 14 determines that the worker is a driver or passenger of the vehicle or machinery, it will not consider the worker as a potential safety risk factor, nor will it generate a warning notification 33.

Additionally, when the hazard identification module 14 detects that the central coordinates of a worker have entered any of the aforementioned restricted area, it immediately generates a warning notification 33 to inform the management personnel for further action, preventing the worker from entering the restricted area. This effectively enables monitoring and management the construction site, enhancing the safety of the work.

Furthermore, the application notification module 15 simultaneously stores the warning notification 33 in the server's temporary storage (not shown in figure), such as Redis. If there is a need to access workplace images in the event of a subsequent accident, historical data at the time may be ensured for evidence.

In an embodiment, as shown in FIG. 2, the hazard identification system 1 of the present disclosure may further include an image augmentation module 21, which first adjusts the image size of (resize) the raw image 31 and then applies multiple data augmentation methods to the raw images 31 to generate a larger set of augmented images 41 for training the machine learning model, which may improve its accuracy in image detection. Here, the image augmentation module 21 only augments the train dataset in the raw image 31.

Specifically, when adjusting the size of the raw image 31, if the longest side of an image is determined to exceed 1920 pixels, the longest side is resized to 1920 pixels. Subsequently, if the shortest side of the image is determined to be less than 32 pixels, the shortest side is resized to 32 pixels.

After completing the image resizing process, various data augmentation methods are randomly applied to augment the dataset. In an embodiment, the image augmentation module 21 employs the iaa. Sometimes technique for data augmentation. The augmentation methods used include random flipping, rotation, brightness adjustment, contrast adjustment, Gaussian blur, cropping, adding salt-and-pepper noise, elastic transformation, addition of motion blur, X-axis shearing, Y-axis shearing, sharpening, piecewise affine transformation, gray scaling, saturation adjustment, gamma contrast adjustment, color temperature adjustment, perspective transformation, coarse random dropout, color inversion, addition of Gaussian noise, addition of Poisson noise, Dropout2d, edge detection, HSV color space modification, brightness modification, and addition of splash effects.

In an embodiment, as shown in FIG. 3, the hazard identification system 1 of the present disclosure may further include a user management module 22, which performs authentication based on the user account and password. If the authentication is successful, the permission authentication 42 is output to the intelligent image analysis module 110 to enable object detection. If the authentication fails, such as when login attempts exceed three unsuccessful attempts, the rejection authentication 43 is output to the application notification module 15 to notify the abnormal login activities and stores the records in the temporary storage area.

Specifically, in an embodiment, the user management module 22 uses JSON Web Token (JWT) to perform identity authentication and manage access frequency, preventing unauthorized access and protect embodiments of the system from distributed denial-of-service (DDoS) attacks. User accounts and passwords are stored in the server's database and encrypted using a hash function. Upon login, a token will be generated. During the validity period of the token, the user may operate embodiments of the system through the application interface. Once the validity period of the token expires, the user must log in again to ensure the security of embodiments of the system.

### Example

This example is used to demonstrate the application of embodiments of the system of the present disclosure in detecting workplace images and identifying hazards.

In this example, the image receiving module 11 receives the real-time monitoring image of the work site from the network and outputs the raw image 31. Next, the image amplification module 21 receives the raw image 31, adjusts the image size appropriately, then employs the iaa. Sometimes technique to randomly apply various data augmentation methods, ultimately expanding the dataset to approximately 50,000 augmented images 41. The specific data augmentation methods used, and their corresponding command codes are detailed in Table 1.

TABLE 1

| Command codes for data augmentation methods | Corresponding meaning |
|---|---|
| iaa.Sometimes(0.5, iaa.Flipud( )) | 50% chance to flip upside down |
| iaa.Sometimes(0.5, iaa.Fliplr( )) | 50% chance of flipping left or right |
| iaa.Sometimes(0.5, iaa.Affine(rotate = (−45, 45))) | 50% chance to rotate |
| iaa.Sometimes(0.5, iaa.Resize((0.7, 1.3))) | 50% chance to resize |
| iaa.Sometimes(0.4, iaa.Multiply((0.8, 1.2))) | 40% chance to change the brightness |
| iaa.Sometimes(0.4, iaa.LinearContrast((0.8, 1.2))) | 40% chance to change the contrast |
| iaa.Sometimes(0.3, iaa.GaussianBlur(sigma = (0, 0.5))) | 30% chance of Gaussian blur |
| iaa.Sometimes(0.4, iaa.Crop(percent = (0, 0.3))) | 40% chance of cropping |
| iaa.Sometimes(0.3, iaa.SaltAndPepper(0.02)) | 30% chance to add salt and pepper |
| | noise |
| iaa.Sometimes(0.3, iaa.ElasticTransformation(alpha = (0, | 30% chance of performing elastic |
| 30), sigma = 10)) | transformation |
| iaa.Sometimes(0.2, iaa.MotionBlur(k = 15, angle = [−45, | 20% chance to add motion blur |
| 45])) | |
| iaa.Sometimes(0.4, iaa.ShearX((−40, 40))) | 40% chance of X-axis shearing |
| iaa.Sometimes(0.4, iaa.ShearY((−40, 40))) | 40% chance of Y-axis shearing |
| iaa.Sometimes(0.3, iaa.Sharpen(alpha = (0, 0.5), | 30% chance to sharpen |
| lightness = (0.8, 1.2))) | |
| iaa.Sometimes(0.2, iaa.PiecewiseAffine(scale = (0.01, | 20% chance of performing piecewise |
| 0.03))) | affine transformation |
| iaa.Sometimes(0.3, iaa.Grayscale(alpha = (0.0, 1.0))) | 30% chance of performing grayscale |
| iaa.Sometimes(0.3, iaa.AddToHueAndSaturation((−30, | 30% chance to change hue and |
| 30))) | saturation |
| iaa.Sometimes(0.3, iaa.GammaContrast((0.5, 1.5))) | 30% chance to change Gamma |
| | contrast |
| iaa.Sometimes(0.3, | 30% chance change color |
| iaa.ChangeColorTemperature((3300, 6500))) | temperature |
| iaa.Sometimes(0.2, | 20% chance of performing |
| iaa.PerspectiveTransform(scale = (0.01, 0.1))) | perspective transform |
| iaa.Sometimes(0.2, iaa.CoarseDropout((0.0, 0.05), | 20% chance of coarse random |
| size_percent = (0.02, 0.25))) | dropout |
| iaa.Sometimes(0.2, iaa.Invert(0.3)) | 20% chance to invert color |
| iaa.Sometimes(0.2, | 20% chance to add Gaussian Noise |
| iaa.AdditiveGaussianNoise(scale = (0, 0.05*255))) | |
| iaa.Sometimes(0.2, iaa.AdditivePoissonNoise(lam = (0, | 20% chance to add Poisson Noise |
| 30))) | |
| iaa.Sometimes(0.3, iaa.Dropout2d(p = (0.1, 0.3))) | 30% chance of performing |
| | Dropout2d |
| iaa.Sometimes(0.2, iaa.EdgeDetect(alpha = (0.2, 0.5))) | 20% chance of performing edge |
| | detection |
| iaa.Sometimes(0.2, | 20% chance to change HSV color |
| iaa.WithColorspace(to_colorspace = “HSV”, | space |
| from_colorspace = “RGB”, | |
| children = iaa.WithChannels(0, iaa.Add((10, 50))))) | |
| iaa.Sometimes(0.4, iaa.AddToBrightness((−30, 30))) | 40% chance to change the brightness |
| iaa.Sometimes(0.4, | 40% chance to add spatter effect |
| iaa.imgcorruptlike.Spatter(severity = 1)) | |

Next, the 50,000 augmented images 41 are used to train a machine learning model, and the trained machine learning model is used to perform image detection in the image detection module 13 using an artificial intelligence algorithm. The artificial intelligence algorithm used in this example is the YOLOv8x model of the object detection algorithm, with a total of 268 layers, 68133198 parameters, 0 gradients, and a floating-point operation per second (FLOPS) rate of 257.4 GFLOPS. The test dataset contains 945 images with a total of 8,651 instances; without SAHI post-processing, the model accuracy evaluation module 121 is used for analysis, revealing that in this example, the YOLO algorithm demonstrates an overall performance with a precision of 0.824, a recall of 0.551, an mAP50 of 0.63, and an mAP50-95 of 0.379.

In addition, the detection performance of each object in the image is shown in Table 2.

TABLE 2

| Detected Objects | Precision | Recall | mAP50 | mAP50-95 |
|---|---|---|---|---|
| Worker | 0.856 | 0.56 | 0.649 | 0.435 |
| With helmet | 0.908 | 0.657 | 0.739 | 0.444 |
| With mask | 0.859 | 0.584 | 0.658 | 0.44 |
| With safety vest | 0.882 | 0.649 | 0.763 | 0.502 |
| Without helmet | 0.795 | 0.415 | 0.51 | 0.239 |
| Without mask | 0.78 | 0.622 | 0.625 | 0.261 |
| Without safety vest | 0.872 | 0.485 | 0.606 | 0.375 |
| Safety cone | 0.725 | 0.439 | 0.503 | 0.234 |
| Machinery | 0.866 | 0.689 | 0.776 | 0.588 |
| Vehicle | 0.701 | 0.406 | 0.476 | 0.268 |

Furthermore, when combined with SAHI post-processing, the mAP50 of YOLO may be significantly improved to 0.68. This demonstrates that combining with SAHI post-processing enhances the detection performance of small objects in complex environments.

As described above, after the image detection module 13 detects an object, a detected image 32 is obtained. The detected image 32 uses detection frames of different colors to display the status of each detected object. As an example, as shown in FIG. 4, if a worker is detected, an orange detection frame is displayed; if the worker is detected to be wearing a safety vest or helmet, a green detection frame is displayed; and if the worker is detected not wearing a safety vest, a red detection frame is displayed. As another example, as shown in FIG. 5, if a vehicle or machinery is detected, a yellow detection frame is displayed; if a worker is detected, an orange detection frame is displayed and if the worker is detected to be wearing a safety vest, a green detection frame is displayed.

In addition, when the hazard identification module 14 detects the presence of safety risks in the image, such as worker not wearing safety vest as shown in the detected image 32 in FIG. 4, worker being too close to vehicles or machinery as shown in FIG. 5, or worker or vehicles entering a restricted area surrounded by traffic cones as shown in FIG. 6 and FIG. 7, a warning notification 33 is immediately generated. Specifically, the warning notification 33 includes warning words, such as “someone is not wearing a safety vest”, “someone is too close to the machinery”, “someone has entered the restricted area”, and the like, and the corresponding detected image 32, and is output to application notification module 15. The application notification module 15 promptly transmits the warning notification 33 along with the corresponding date and time to the user application. In this example, as shown in FIG. 8, LINE Notify is used as the user application, allowing management personnel to quickly and easily understand the situation in real-time via mobile devices. Additionally, the image detection module 13 sends the detected image 32 to the streaming webpage display module 16, which uploads the image to a live-streaming platform. This enables management personnel to monitor the workplace conditions at any time conveniently.

In summary, in this example, the image receiving module 11 of the hazard identification system 1 of the present disclosure receives the raw image 31 from the live streaming networks, and the image augmentation module 21 uses the iaa. Sometimes technique to augment the images to a total of 50,000 augmented images 41 for training the machine learning model. The image detection module 13 uses the YOLO algorithm for object detection, generating detected images 32. The hazard identification module 14 analyzes these detected images 32 to determine the presence of any hazardous situations and outputs warning notifications 33 to the application notification module 15, which transmits the warning notifications 33 to the user application to notify the management personnel.

In other examples, the hazard identification system of the present disclosure may be used not only for workplace hazard detection, but also for monitoring whether there are machines or vehicles parked illegally, as shown in FIG. 9. The workplace scene and whether there are any violations may be checked at any time through the webpage. It may be used as a central monitor console.

The above embodiments should be understood as illustrative examples of the present disclosure, provided to demonstrate its features and not intended to be exhaustive or limited to the specific forms disclosed. Many modifications and variations will be apparent to those of ordinary skill in the art without departing from the scope and spirit of the disclosure. The embodiments were chosen and described in order to best explain the principles of the creation and the practical application, and to enable others of ordinary skill in the art to understand the various embodiments with various modifications as are suited to the particular use contemplated.

### LIST OF REFERENCE NUMERALS

1: hazard identification system
11: image receiving module
110: intelligent image analysis module
12: model training module
121: model accuracy evaluation module
13: image detection module
14: hazard identification module
15: application notification module
16: streaming webpage display module
21: image augmentation module
22: user management module
31: raw image
32: detected image
33: warning notification
41: augmented images
42: permission authentication
43: rejection authentication

What is claimed is:

1. An artificial intelligence hazard identification system, which is applicable to a server, comprising:
(i) an image receiving module configured to receive real-time images of a workplace via a network and output raw images;
(ii) an intelligent image analysis module connected to the image receiving module, which includes:
a model training module configured to train a machine learning model using the raw images to obtain a trained model;
an image detection module configured to analyze the raw images using the trained model with artificial intelligence algorithms to generate detected images;
(iii) a hazard identification module, connected to the intelligent image analysis module, configured to analyze objects in the detected images and, if safety risk factors are identified, generate and output a warning notification;
(iv) an application notification module, connected to the hazard identification module, configured to transmit the warning notification to a user application for notification.

2. The artificial intelligence hazard identification system according to claim 1, wherein the safety risk factors include at least one condition of: personnel not wearing safety protection equipment, personnel being too close to machinery or vehicles, and personnel entering restricted area.

3. The artificial intelligence hazard identification system according to claim 1, wherein the artificial intelligence algorithm is an object detection algorithm; the object detection algorithm is at least one selected from a group consisting of YOLO, Faster R-CNN, Single Shot MultiBox Detector, RetinaNet, EfficientDet and CenterNet.

4. The artificial intelligence hazard identification system according to claim 1, wherein the image detection module uses SAHI post-processing for small object detection.

5. The artificial intelligence hazard identification system according to claim 1, wherein the model training module further includes a model accuracy evaluation module to evaluate accuracy of the trained model.

6. The artificial intelligence hazard identification system according to claim 1, further includes an image augmentation module, which is connected to the image receiving module and the intelligent image analysis module and is configured to adjust image size of the raw images and perform data augmentation on the raw images using multiple data augmentation methods.

7. The artificial intelligence hazard identification system according to claim 1, further includes a streaming webpage display module, which is connected to the intelligent image analysis module and is configured to transmit the detected images to a live webpage to provide real-time images.

8. The artificial intelligence hazard identification system according to claim 6, wherein the data augmentation method includes at least one selected from a group consisting of random flipping, rotation, brightness adjustment, contrast adjustment, Gaussian blur, cropping, adding salt-and-pepper noise, elastic transformation, addition of motion blur, X-axis shearing, Y-axis shearing, sharpening, piecewise affine transformation, gray scaling, saturation adjustment, gamma contrast adjustment, color temperature adjustment, perspective transformation, coarse random dropout, color inversion, addition of Gaussian noise, addition of Poisson noise, Dropout2d, edge detection, HSV color space modification, brightness modification, and addition of splash effects.

9. The artificial intelligence hazard identification system according to claim 1, further comprises a user management module connected to the intelligent image analysis module and the application notification module, and is configured to perform authentication based on user account and password;
if the authentication is successful, a permission authentication is output to the image detection module to enable the image detection module to perform object detection;
if the authentication is failed, a rejection authentication is output to the application notification module to notify an abnormal login attempt.

10. The artificial intelligence hazard identification system according to claim 1, wherein the application notification module stores the warning notification in a temporary storage area of the server.
